(19) United States
(12) Patent Application Publication
(10) Pub. No.: US 2015/0001334 A1
(43) Pub. Date: Jan. 1, 2015

(54) Discoidal Seaplane

(71) Applicant: Wendell Olson, San Francisco, CA (US)

(72) Inventor: Wendell Olson, San Francisco, CA (US)

(21) Appl. No.: 14/312,447

(22) Filed: Jun. 23, 2014

Related U.S. Application Data
(63) Continuation-in-part of application No. 13/460,851, filed on May 1, 2012, now abandoned.
(60) Provisional application No. 61/481,364, filed on May 2, 2011.

(51) Int. Cl. B64C 37/00; B64C 39/08; B60V 3/06; B60F 5/02; B64B 1/40; B64C 39/06; B64C 35/00

(52) U.S. Cl. CPC B64C 37/00; B64C 39/06; B64C 39/08; B64C 35/00; B60F 5/02; B64B 1/40; B60V 3/06
USPC 244/2

(57) ABSTRACT

A flying vehicle, comprising a discoidal secondary wing and two airfoil primary wings. The airfoil primary wings provide out-of-surface-effect lift that acts as the main lift force for the vehicle. The discoidal secondary wing provides lift via the surface effect, stabilizes the vehicle, provides a mounting surface for solar panels, and acts as a pontoon for water landings. The vehicle can also include a retractable toroidal or round balloon to provide additional lift. The vehicle is fully scalable, from children's toys to passenger vehicles.

### CROSS-REFERENCE TO RELATED APPLICATIONS

The present application is a continuation-in-part of U.S. patent application Ser. No. 13/460,851, which claims the benefit of U.S. provisional patent application No. 61/481,364, filed May 2, 2011, which is incorporated herein by reference in its entirety.

### FIELD OF THE INVENTION

The invention pertains to aircraft designed to fly at a low altitude, and specifically to discoidal-shaped aircraft designed to fly over water.

### BACKGROUND OF THE INVENTION

The concept of surface effect flight is well known in the art of aviation. An aircraft utilizing surface effect becomes airborne by developing dynamic air pressure between the vehicle and a surface, sufficient to maintain sustained flight near the surface. Such aircraft are typically used to fly over water, since unlike dry land, the surface of a body of water is near-perfectly flat and offers no unexpected obstacles to a low-flying aircraft.

While many surface-effect vehicles have the appearance of conventional winged aircraft—a central fuselage with wings extending on either side—there are disadvantages to the winged design. For example, if the aircraft tilts and the tip of a wing touches the water's surface, the aircraft may crash. Thus, many alternative designs have been developed, generally combining the surface-effect wing with another means of supporting the aircraft and preventing tipping. Several such designs use a hovercraft function in combination with the surface-effect wing, which enables the aircraft to take off and land vertically, but which adds complexity to the design. U.S. Pat. No. 5,464,069 to Gifford discloses such a design.

Other designs take advantage of the forward motion of the aircraft for both the surface effect and for conventional lifting force. U.S. Pat. No. 5,727,495 to Reslein discloses a surface effect vehicle that also includes an airfoil spaced above the vehicle body that provides additional lifting force and stabilizes the aircraft. However, due to the small size of the aircraft, there is a limitation on how much lift it can develop. Furthermore, because of the small size of the surface-effect wing, the aircraft is vulnerable to tipping.

### SUMMARY OF THE INVENTION

A primary object of the present invention is to provide a new and improved flying vehicle that utilizes surface effect for part of its lifting force and that does not require a hovercraft function to remain in the air.

A further object of the present invention is to provide a vehicle with a discoidal secondary wing that provides lift via the surface effect and furthermore acts to stabilize the aircraft, as well as at least one primary wing that provides out of surface effect lifting force in response to the forward motion of the vehicle.

A further object of the present invention is to provide a seaplane that is not vulnerable to tipping in any direction.

In accordance with the preferred embodiment of the present invention, there is provided a vehicle with a discoidal secondary wing and two double-layer primary wings disposed above the secondary wing. The vehicle is also equipped with propellers or similar means of enabling forward motion, driven by electric motors, internal combustion engines, or other means known in the art.

The discoidal secondary wing serves several functions. One function is to provide surface effect lifting force to assist in lifting the aircraft. Another function is to stabilize the vehicle and prevent flipping when landing, taking off, or just settled in the water. For that purpose, the discoidal secondary wing is equipped with various control features to keep it stable, including but not limited to controllable flaps or gyroscopes. Another function is to keep the primary wings from fouling whThe discoidal secondary wing can also be built in such a way as to enable the vehicle to float when in water, thus serving as a pontoon. Furthermore, due to its large surface area, the discoidal secondary wing can also serve as a mount for solar panels.

In the preferred embodiment, the primary wings are double-layered; each wing has two airfoils, one above the other, slightly staggered to maximize lift force. This provides more lift force than a single-layered wing, as well as a lower profile, to allow an unobstructed view for the passengers.

Another embodiment of the invention also includes a helium or hot-air balloon, or a plurality of balloons, to assist in lifting the vehicle. The balloon or balloons are retractable so that they can be stowed when not in use. When the vehicle is in the air, the balloon or balloons can be deployed and inflated. The balloon or balloons can be any shape, though the preferred embodiment is a toroidal balloon concentric with the axis of the discoidal secondary wing, attached to the discoidal secondary wing by cords or wires. Another embodiment is a spherical balloon located directly above the cabin.

The vehicle is fully scalable; it can be built in any size, ranging from children's toys to full-scale passenger vehicles. As a full-size passenger vehicle, it can attain the speed of 70 miles per hour while flying at a height of 5-10 feet.

### LIST OF FIGURES

FIG. 1 shows a view of an embodiment of the flying vehicle.

FIG. 2 shows another embodiment of the discoidal secondary wing.

FIG. 3 shows a side view of the preferred embodiment of the flying vehicle.

FIG. 4 shows a zoomed-in view of the primary wings.

FIG. 5 shows a view of an alternate embodiment of the flying vehicle.

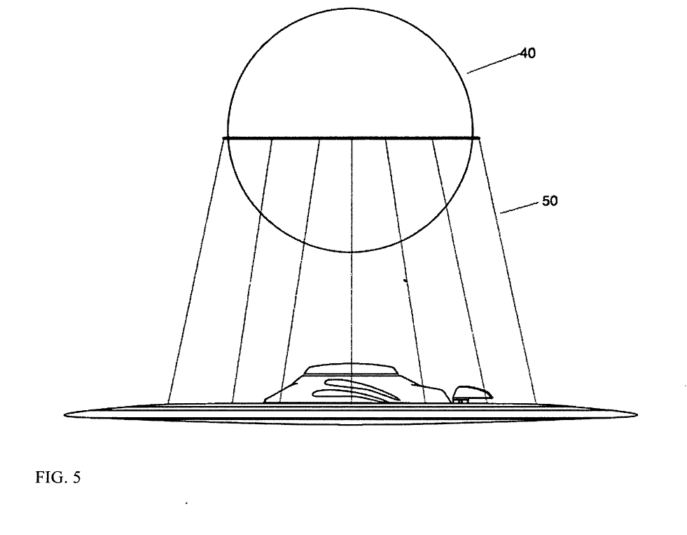

### DETAILED DESCRIPTION OF THE PREFERRED EMBODIMENT

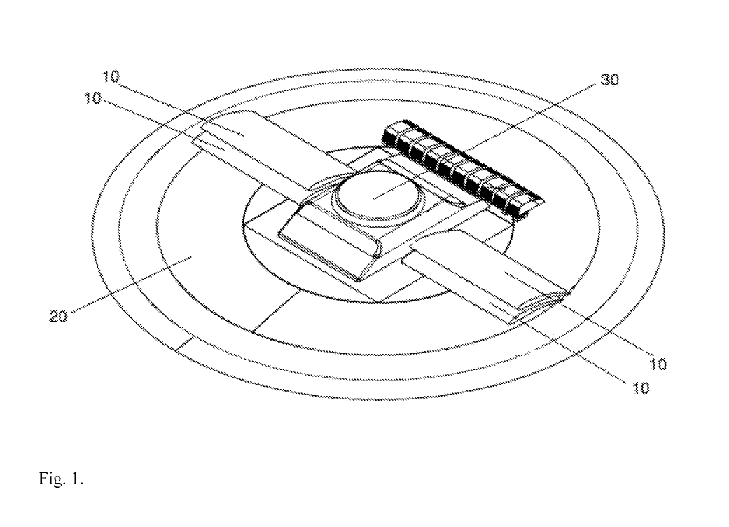

FIG. 1 shows a view of the preferred embodiment of the flying vehicle. Primary wings 10 are located above discoidal secondary wing 20. Cabin 30 is located at the center of the discoidal secondary wing 20, and offers a 360° view to the cabin occupants. The discoidal secondary wing 20 provides lift force via the surface effect, stabilizes the vehicle, acts as a pontoon when the vehicle lands, and provides a mounting surface for solar panels. The discoidal secondary wing also offers the aesthetic advantage of being a “flying saucer”, which is important for recreational flights.

The primary wings 10 are preferably airfoils positioned in such a way as to generate lift when the vehicle is propelled forward. While the Figure shows two sets of primary wings, positioned one above the other, any number of primary wings may be used. When more than one set of primary wings is used, the upper set is preferably horizontally displaced with respect to the lower set, to maximize lift. The primary wings may be made of any material that is conventionally used for aircraft, such as aluminum, fiberglass, plastic, or wood, as long as the material is strong enough to support the forces required, light enough to not add unnecessary weight to the aircraft, and not vulnerable to corrosion in salt water (since the aircraft will most likely be exposed to salt water spray). The tips of the primary wings preferably do not extend beyond the discoidal secondary wing, to prevent them from touching the water if the aircraft tilts while flying.

The discoidal secondary wing 20 is preferably shaped like a disc that is thinner on the edges than in the middle. It is preferably made of a material that is lighter than water, to enable flotation. It may be hollow inside or filled with plastic foam. The purpose of the discoidal secondary wing is to stabilize the aircraft in case of tipping (i.e. to prevent the primary wings from touching the water in case the aircraft tips), to provide extra lift via the surface effect, and to provide flotation for water landings. Because the discoidal secondary wing is a disc, it works better than pontoons or sponsons to stabilize the aircraft against tipping; it can stabilize the aircraft against tipping in any direction, not just side-to-side.

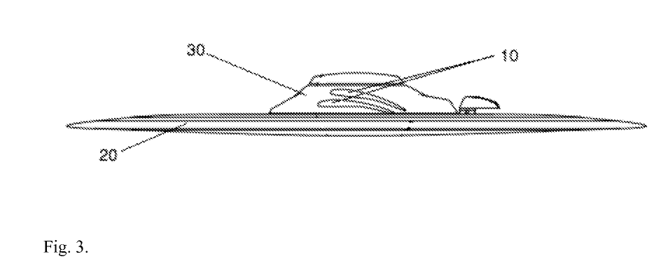

The exact profile of the discoidal secondary wing preferably comprises two spherical segments joined together, as shown in FIG. 3. This ensures that the air underneath the discoidal secondary wing passes through a narrowing channel, thus providing extra lift for the aircraft. While the discoidal secondary wing is shown in the Figure as rotationally symmetrical around the center, it may be shaped differently in the front half than in the back half, or may be asymmetrical in other ways as long as it provides some lift for the aircraft via surface effect and extends beyond the tips of the primary wings to prevent tipping.

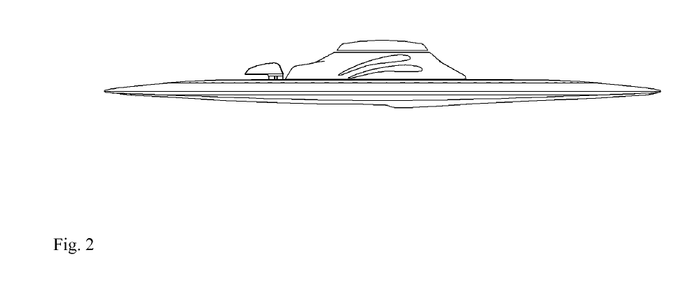

FIG. 2 shows another embodiment of the shape of the discoidal secondary wing, comprising a step on the bottom surface of the wing. The step is intended to facilitate taking off from the water, since as the aircraft tilts during takeoff, the forward surface of the discoidal secondary wing gets free of the water earlier, thus reducing the adhesion between the water and the wing and reducing the force required to take off. Other possible shapes may also be apparent to one of reasonable skill in the art, as long as the shape is symmetrical and provides lift via the surface effect.

The discoidal secondary wing may comprise additional features to prevent tipping. For example, it may comprise a gyroscope to keep it stable, or controllable flaps to control its position. In the preferred embodiment, the discoidal secondary wing comprises a gyroscope to keep it stable and to prevent tipping in any direction.

The aircraft is propelled forward by jet engines, propellers, or any other devices for providing thrust known in the art of aircraft design. In the preferred embodiment, the aircraft is propelled by at least one jet engine (not shown) mounted onto the discoidal secondary wing. The aircraft may also be propelled by propellers that provide forward thrust.

FIG. 3 shows a side view of the flying vehicle, showing the discoidal secondary wing 20, the cabin 30, and the primary wings 10. The cabin 30 preferably provides space for the pilot and any passengers or cargo that the flying vehicle can carry. As shown in the Figure, it is preferably located approximately in the center of the discoidal secondary wing, to increase stability, and comprises windows that enable the pilot and passengers to see in every direction. In the preferred embodiment, the cabin 30 is not integrated into the discoidal secondary wing 20, but rather is a separate entity mounted onto the discoidal secondary wing; this increases the strength of the discoidal secondary wing and allows for a modular design, easy change out of modules, and with alternative configurations of cabins, and easier emergency egress from the main body using the cabin or sub-structure of the cabin.

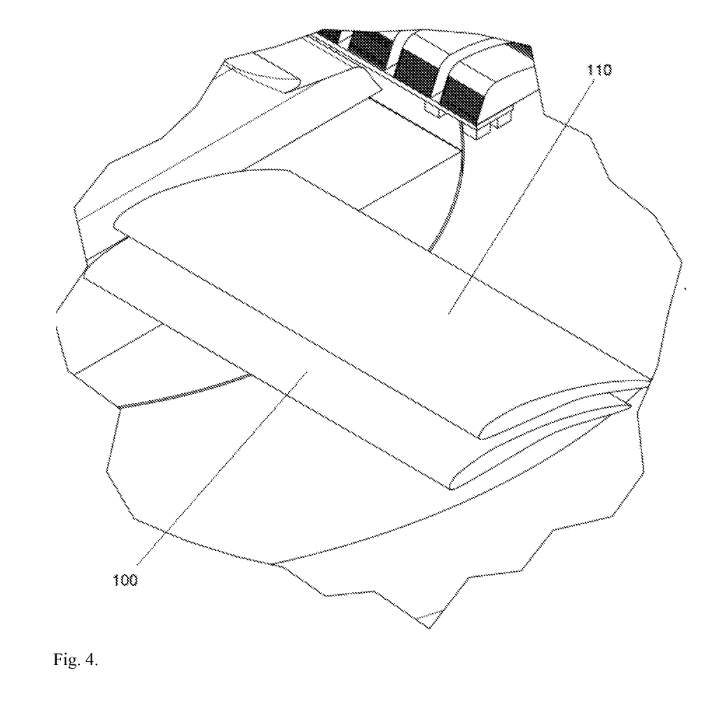

FIG. 4 shows the placement of the primary wings in more detail. As discussed above, the lower airfoil 100 is slightly horizontally displaced from the upper airfoil 110. This maximizes the lift force generated by each airfoil. As discussed above, any number of sets of primary wings may be used. The primary wings may be the same size or different sizes and shapes.

The discoidal secondary wing may also provide mounting space for solar panels to assist in powering the flying vehicle. While a flying vehicle requires a great deal of power, and it may not be possible for on-board solar panels to provide the entire power requirement for such a vehicle, such solar panels may provide enough power to illuminate the cabin or the instrument panel, to provide air-conditioning or heating, and so on. The solar panels may be any standard type of solar panels that do not corrode when exposed to salt water spray. The solar panels may cover the entire upper surface of the discoidal secondary wing, or only parts of the upper surface thereof.

The discoidal secondary wing is also preferably used for flotation when the flying vehicle is not in the air. Since the flying vehicle is used to fly over water, it will need to make water landings and to take off from the water. Thus, the discoidal secondary wing is preferably made in such a way that it provides enough buoyancy in water to enable the flying vehicle to float. In the preferred embodiment, the discoidal secondary wing comprises a “step” in its cross-section, as shown in FIG. 2, that enables an easier takeoff for the flying vehicle. When the aircraft is taking off, the water exerts a downward force on the discoidal secondary wing, making it harder for the flying vehicle to take off. If the discoidal secondary wing comprises a “step” as shown in FIG. 2, the suction between the water and the wing is broken, and the flying vehicle does not require as much force to take off.

The flying vehicle may require additional lift in addition to the lift provided by the primary wings and the discoidal secondary wing. It may also require a means of providing upward force when the aircraft is taking off, to break the contact between the water and the discoidal secondary wing. It may also require a way to provide lift that does not require increased forward thrust, and thus, bigger and less-efficient engines. To solve the problems outlined above, a balloon may be used to assist in lifting the aircraft. FIG. 6 shows an alternate embodiment of the flying vehicle, showing balloon 40 attached by cables 50 to the flying vehicle. Balloon 40 is a spherical balloon that can be filled with helium, hot air, or any other gas that can provide lift. The size of the balloon is preferably such that it can provide a meaningful amount of lift for the flying vehicle. It is preferably made of canvas, Mylar, or any other material that is used for balloons of that size and application. While the Figure shows a spherical balloon, other balloon shapes are also possible, such as a toroidal balloon. In another embodiment, multiple balloons are used. The balloons may be printed with advertising messages or graphics.

The balloon or balloons may be attached to the flying vehicle when required and removed and stowed elsewhere when not needed. In an alternate embodiment, the discoidal secondary wing comprises a space in which the balloon or balloons may be stored when not in use. In that embodiment, when the pilot of the flying vehicle requires extra lift, he or she may be able to deploy the balloon or balloons during the flight and inflate them with hot air or helium automatically. This may be useful for safety reasons (i.e. if the aircraft runs out of gas and needs some extra lift to get to its destination), or for reasons of noise (if the balloon provides extra lift, the aircraft may not need as much forward thrust, thus not requiring as much noisy engine activity). In an alternate embodiment, the balloon or balloons may also be capable of automatic deflation so that they can be deflated and stowed away during a flight when no longer needed.

While exemplary embodiments have been described above, those skilled in the art will readily realize that numerous changes, modifications, and substitutions may be made without departing from the spirit and scope of this invention, which is limited only by the appended claims.

1. A flying vehicle, comprising:
a discoidal secondary fixed wing that utilizes surface effect to provide lift force and stabilizes the flying vehicle, said discoidal secondary fixed wing being able to float in water;
at least one primary wing located above the discoidal secondary wing, said primary wing providing lift force.

2. The flying vehicle of claim 1, comprising two primary wings.

3. The flying vehicle of claim 1, where the discoidal secondary fixed wing comprises means of stabilizing the vehicle to prevent tipping.

4. The flying vehicle of claim 1, where the discoidal secondary fixed wing comprises controllable flaps to prevent tipping.

5. The flying vehicle of claim 1, where the discoidal secondary fixed wing comprises a gyroscope to prevent tipping.

6. The flying vehicle of claim 1, further comprising a balloon structure located above the discoidal secondary fixed wing, said balloon structure providing lift force to the flying vehicle.

7. The flying vehicle of claim 1, where the balloon structure is retractable into the discoidal secondary fixed wing when not needed.

8. The flying vehicle of claim 1, where the balloon structure is toroidal in shape and concentric with the discoidal secondary fixed wing.

9. The flying vehicle of claim 1, where each primary wing comprises two airfoils, a top airfoil and a bottom airfoil.

10. The flying vehicle of claim 9, where the top airfoil is slightly horizontally displaced from the bottom airfoil.

11. The flying vehicle of claim 1, further comprising a solar panel located on the upper exposed surface of the discoidal secondary fixed wing.
